(19) United States
(12) Patent Application Publication
(10) Pub. No.: US 2004/0049428 A1
(43) Pub. Date: Mar. 11, 2004

(54) Wireless environmental sensing in packaging applications

(76) Inventors: John Pius Soehnlen, Loveland, OH (US); Steven Robert Van Fleet, Pawling, NY (US)

Correspondence Address: Lorri W. Cooper, Esq., JONES, DAY, REAVIS & POGUE, North Point, 901 Lakeside Avenue, Cleveland, OH, 44114, US

(21) Appl. No.: 10/235,346

(22) Filed: Sep. 5, 2002

(51) Int. Cl. G06F 17/60

(52) U.S. Cl. 705/25

(57) ABSTRACT

A system for monitoring an environmental condition associated with an item of inventory along a distribution chain having a plurality of locations comprises at least one item of inventory, an RF transponder associated with the item of inventory, and at least one environmental condition sensor in communication with the RF transponder. The system includes a power source for powering the RF transponder and the environmental condition sensor to record an environmental condition. The system also includes a log of location data, a log of environmental condition data, and a reporting infrastructure for processing the location data and the environmental condition data. A method for tracking an environmental condition along a distribution chain is also included.

### FIELD OF THE INVENTION

The claimed invention relates to wireless communication systems. In particular, the invention relates to the use of sensing devices coupled to RFID components on items of inventory for monitoring, storing, and relaying environmental and other information.

### BACKGROUND

Radio frequency identification (RFID) technology has been used for wireless automatic identification. An RFID system typically includes a transponder, an antenna, and a transceiver with a decoder. The transponder, which typically includes a radio frequency integrated circuit, and antenna may be positioned on a substrate, such as an inlet or tag. The antenna serves as a pipeline between the circuit and the transceiver. Data transfer between the transponder and transceiver is wireless. RFID systems may provide non-contact, non-line of sight communication.

RF transponder “readers” utilize an antenna as well as a transceiver and decoder. When a transponder passes through an electromagnetic zone of a reader, the transponder is activated by the signal from the antenna. The transceiver decodes the data on the transponder and this decoded information is forwarded to a host computer for processing. Readers or interrogators can be fixed or handheld devices, depending on the particular application.

Several different types of transponders are utilized in RFID systems, including passive, semi-passive, and active transponders. Each type of transponder may be read only or read/write capable. Passive transponders obtain operating power from the radio frequency signal of the reader that interrogates the transponder. Semi-passive and active transponders are powered by a battery, which generally results in a greater read range. Semi-passive transponders may operate on a timer and periodically transmit information to the reader. Transponders may also be activated when they are read or interrogated by a reader. Transponders may control their output, which allows them to activate or deactivate apparatus remotely. Active transponders can initiate communication, whereas passive and semi-passive transponders are activated only when they are read by another device first. Active transponders can supply instructions to a machine and then the machine may then report its performance to the transponder. Multiple transponders may be located in a radio frequency field and read individually or simultaneously. Sensors may be coupled to the transponders to sense an environmental condition.

### SUMMARY

According to the invention, a system is provided for monitoring an environmental condition associated with an item of inventory along a distribution chain having a plurality of locations. The plurality of locations include at least a point of origin and a final destination. The system comprises at least one item of inventory, an RF transponder associated with the at least one item of inventory, at least one environmental condition sensor in communication with the RF transponder on the at least one item of inventory, and a power source for powering the RF transponder and the at least one environmental condition sensor. The transponder includes an RF processor having an antenna coupled to the RF processor. The RF transponder receives an environmental condition from the environmental condition sensor for storage as environmental condition data. The system also includes a log of location data, a log of environmental condition data, and a reporting infrastructure for processing the location data and the environmental condition data.

The power source may comprise a battery that is coupled to the sensor and the transponder, or an RF reader that powers the transponder and sensor to transmit a sensed reading to the transponder. The reporting infrastructure may include a computer processor.

The invention also concerns a method of tracking an environmental condition associated with an item of inventory along a distribution chain having a plurality of locations. The plurality of locations include at least a point of origin and a final destination. The method comprises providing an item of inventory having an associated RF transponder, an environmental condition sensor, and a power source. The power source is for powering the environmental condition sensor to sense an environmental condition. The method also includes repeatedly powering the RF transponder and the environmental condition sensor as the item of inventory travels along the distribution chain to read the environmental condition and generate a log of environmental condition data. The method further includes repeatedly determining a location of the item of inventory as the item of inventory travels along the distribution chain and generating a log of location data and correlating the log of location data and the log of environmental condition data using a reporting infrastructure.

### BRIEF DESCRIPTION OF THE DRAWING FIGURES

FIG. 1 is a schematic view of one embodiment of a distribution chain for an item of inventory according to the system of the present invention, showing electronic recording of environmental condition data and manual recording of location data;

FIG. 2 is a graph showing an example of temperature as a function of location and time for an item of inventory that travels along a distribution chain like that in FIG. 1;

FIG. 3 is a schematic view of another embodiment of a distribution chain according to the invention showing electronic recording of environmental condition data and manual recording of location data;

FIG. 4 is a schematic view of another embodiment of a distribution chain according to the invention showing electronic recording of environmental condition data and manual recording of location data;

FIG. 5 is a graph showing another example of temperature as a function of location and time for an item of inventory that travels along a distribution chain like that of FIG. 4;

FIG. 6 is a schematic view of yet another embodiment of a distribution chain according to the invention showing electronic recording of environmental condition data and manual recording of location data;

FIG. 7 is a schematic view of another embodiment of a distribution chain according to the invention showing electronic recording of both environmental condition data and location data;

FIG. 8 is a graph showing an example of shock as a function of location and time for an item of inventory that travels along a distribution chain like that of FIG. 7;

FIG. 9 is a schematic view of another embodiment of a distribution chain according to the invention showing electronic recording of both environmental condition data and location data;

FIG. 10 is a schematic view of yet another embodiment of a distribution chain according to the invention showing electronic recording of both environmental condition data and location data;

FIG. 11 is a schematic view of another embodiment of a distribution chain according to the invention showing electronic recording of both environmental condition data and location data;

FIG. 12 is a perspective view of a paper roll showing the inner core of the paper roll in phantom, with an RF inlet, sensor and battery installed on the core according to the present invention;

FIG. 13 is a perspective view of a box showing an RF inlet, sensor, and battery installed on an exterior surface of the box;

FIG. 14 is a perspective view of a box showing an RF processor, antenna, and sensor installed on an exterior surface of the box; and

FIG. 15 is a schematic view of an item of inventory that incorporates a product positioned inside a product packaging, with the RF transponder and sensor coupled to the item of inventory at a variety of locations according to the present invention.

### DETAILED DESCRIPTION

A system for monitoring an environmental condition associated with an item of inventory 12 and its various components are shown in FIGS. 1-15. The system tracks an environmental condition for an item of inventory 12 along a distribution chain 10. The system preferably includes an RF transponder 14 coupled to the item of inventory and an environmental condition sensor 16 coupled to each transponder 14. A power source is utilized to power the sensor to sense an environmental condition and to transmit the environmental condition data to the transponder. The system also utilizes a log of location data and environmental condition data as a function of time, and a reporting infrastructure for correlating the location and condition data. The system provides an automated means for measuring, recording, and relaying environmental measurements in or about an item of inventory for real time, continuous monitoring of the item's environmental conditions throughout the distribution cycle. The system is useful in foregoing human intervention for measuring and recording physiological and chemical characteristics associated with the item of inventory 12.

The distribution chain 10 has a plurality of locations L and will typically include a point of origin L1, such as a manufacturer or distributor, and a final destination LE, such as a retailer or consumer. The plurality of locations L may also include intermediate locations L2, L3 between the point of origin L1 and the final destination LE. Typical locations among the plurality include the manufacturer, wholesaler, distributor, retailer, and consumer. The point of origin L1 may lie at the manufacturer's warehouse and coincide with the time the item of inventory leaves the manufacturer. Alternatively, the point of origin L1 may be a point before or after the item of inventory 12 leaves the warehouse. It may be desirable to track the item of inventory 12 along the manufacturing process, which would require that the RF transponder 14 and sensor 16 be coupled to the item of inventory 12 at a point before the item of inventory 12 is completed and before it leaves the warehouse. Alternatively, it may be desirable to track the item of inventory 12 from an intermediate point L2, L3, which could be labeled as the point of origin L1. For instance, it may be desirable by a distributor to track the item of inventory 12 after it leaves the distributorship before it arrives at the final destination LE. Moreover, the final destination LE does not necessarily have to correspond to the end user. The final destination LE may alternatively correspond to an intermediate point along the distribution chain 10. Other locations, or fewer locations, may also be utilized in the distribution chain 10, depending on the product and its mechanism for distribution.

FIGS. 1, 3-4, 6-7, and 9-11 show a distribution chain 10 that includes a point of origin L1, a final destination LE, and two intermediate locations L2, L3. The figures are for illustration purposes only, the invention not being limited to or requiring four locations. More than four locations may be utilized. Alternatively, fewer than four locations may be utilized, such as a distribution chain that includes only a point of origin and a final destination.

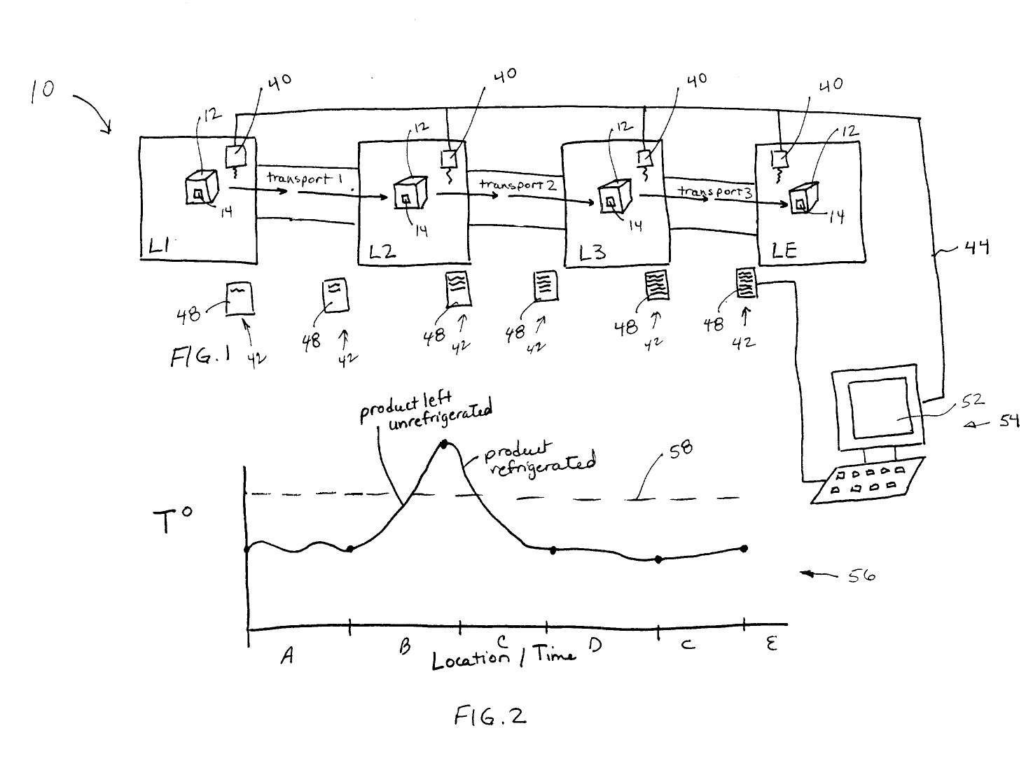

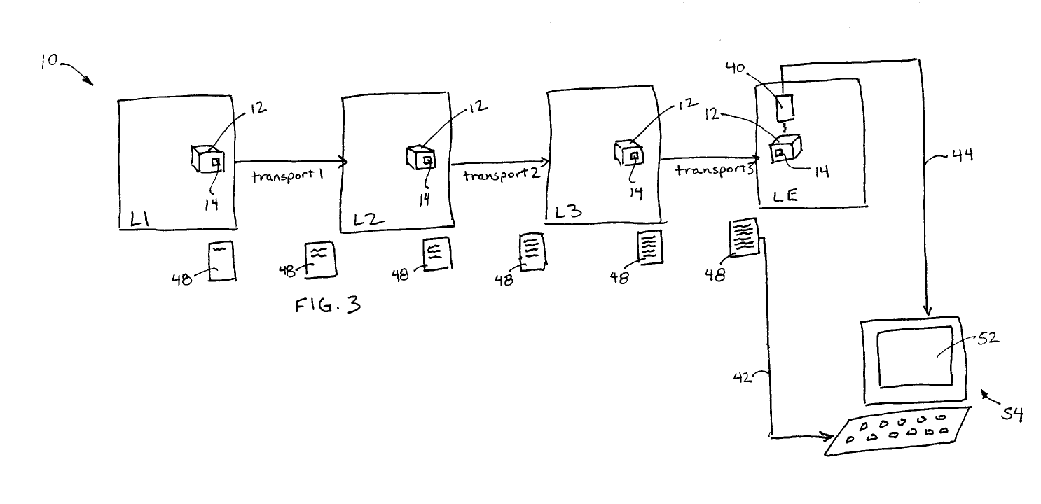

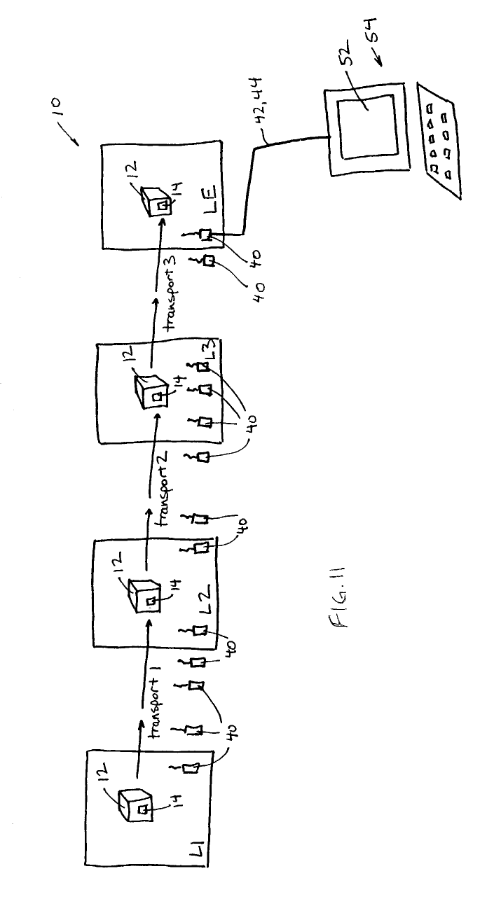

Referring to FIGS. 12-15, the system is centered around an item of inventory 12, such as a roll of paper, a box, a pallet, a packaging substrate, a package, or another item of inventory. The system tracks both the location of the item of inventory 12 as a function of time and an environmental condition as a function of time. The system correlates the location and environmental condition data to provide the user with data for determining whether any defects exist in the inventory that were caused during the distribution process, as shown graphically in FIGS. 2, 5, and 8. For example, items of inventory are often susceptible to damage caused by shock, excessive temperature, or excessive humidity levels, among other factors which are often product specific. The present invention can track these levels and correlate the levels with a location L1, L2, L3, LE for each item of inventory 12 to determine, for instance, if a temperature sensitive product has been left on a loading dock in 90° F. (32.2° C.) heat (FIG. 2), or a shock sensitive item of inventory has been dropped (FIG. 8), or a humidity sensitive item has been left out in the rain. Since the present invention tracks both environmental condition and location data, it is possible to determine where in the distribution chain 10 the damage occurred. This is highly desirable, particularly where an item of inventory 12 passes through a number of locations on its way to its final destination LE.

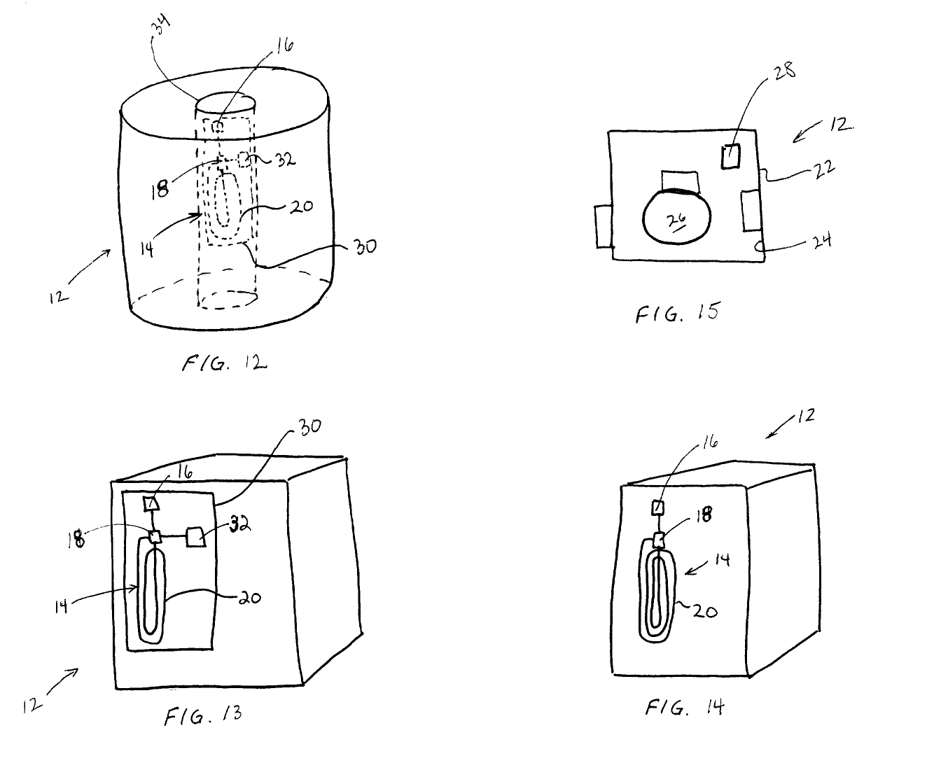

The present system utilizes an RF transponder 14 that is coupled to the item of inventory 12 and an environmental condition sensor 16 electrically coupled to the RF transponder 14. The RF transponder 14 and environmental condition sensor 16 may be incorporated into or onto any package or packaging substrate, including paper, plastic, glass, metal, or hybrid packaging materials. As shown in FIGS. 12-14, the RF transponder 14 includes an RF processor 18 and an antenna 20. The antenna 20 may be onboard the RF processor (not shown), or, in a preferred embodiment shown in FIGS. 12-14, may be a separate antenna 20 that is electrically coupled to the RF processor 18. As discussed above, an item of inventory 12 may take the form of a paper roll, as shown in FIG. 12, a box, as shown in FIGS. 13 and 14, or another structure, as shown schematically in FIG. 15. The item of inventory 12 may be a large container, such as a crate used for carrying furniture or household goods, a carton carrying a plurality of boxed appliances, or individual boxes, or smaller individual boxes that are positioned in a larger box, the invention not being limited to a particular type of inventory.

As shown in the schematic representation in FIG. 15, the electronic components, which comprise the RF transponder 14 and sensor 16, may be associated with an exterior 22 or internal 24 surface of the item of inventory 12, may be positioned on a product 26 inside the item of inventory 12, or may be floating 28 inside the item of inventory and not connected to anything. Furthermore, the electronic components may be positioned on primary, secondary, or other packages. For instance, where a plurality of smaller individual boxes are positioned in a larger box, the electronic components may be coupled to each of the smaller individual boxes, or to the larger box that houses the smaller boxes. In another example, such as a crate used to store and move household furniture and belongings, a particular item of inventory, such as a vase, may be susceptible to breakage caused by excessive shock. It may be desirable to position the electronic components on the vase, while it is unnecessary to position the electronic components on other items of inventory in the crate. Thus, the invention is not limited to a particular location or placement of the RF transponder 14 and sensor 16 on the item of inventory 12.

In a preferred embodiment, as shown in FIGS. 12 and 13, the RF transponder 14 is positioned on an RF inlet 30 and the RF inlet 30 is secured to the item of inventory 12. An RF inlet 30 is typically a thin substrate and the RF processor 18 and the antenna 20 of the RF transponder 14 are positioned on the substrate, as shown in FIGS. 12 and 13. The RF processor 18 and antenna 20 are electrically coupled to one another, either by direct contact or by capacitive coupling. The term “processor” refers generally to a computer that processes or stores information, such as a computer chip. The processor may include a semiconductor circuit having logic, memory, and RF circuitry. The computer chip may be a silicon-based chip, a polymer-based chip, or other chips that are known today or will be developed in the future. The RF processor 18 is preferably read/writable, so that information may be both stored in and read from the processor.

The environmental condition sensor 16 is in communication with the RF processor 18 and may be positioned on the RF inlet 30, also shown in FIGS. 12 and 13. A power source, such as a battery 32, may also be coupled to the RF processor 18 and sensor 16 and positioned on the inlet 30, as shown in FIGS. 12 and 13. Alternatively, the invention also concerns electrical components that do not include a battery, such as the item of inventory 12 shown in FIG. 14, which includes an RF processor 18, an antenna 20 and a sensor 16.

The substrate of the RF inlet 30 may be a paper or polymeric material, such as polyester, among other known materials. In order to facilitate attachment of the RF inlet 30 to the item of inventory 12, a pressure sensitive adhesive, or other attachment medium, may be positioned on one side of the substrate. Alternatively, the inlet 30 may be applied using glues, hot melts, water activated adhesives, or other adhering mediums.

The inlet 30 may be applied to the item of inventory 12 with an automatic application device, such as a label applicator, which can apply the inlet to an external 22 or internal surface 24 of the item of inventory 12 either after it has been assembled or prior to assembly. Alternatively, the inlet 30 may be positioned on a tag and placed inside the item of inventory in a floating manner as a “floating tag” 28, or positioned on or inside the product(s) 26 in the item of inventory 26, as shown schematically in FIG. 15. The inlet 30 may also be applied by hand or with an automated process. When the inlet 30 is positioned on a paper roll, as shown in FIG. 12, the inlet 30 is preferably positioned on the core 34 of the paper roll. In a preferred embodiment, the inlet 30 is positioned on an external surface of the core 34 and the stock of the paper roll is wrapped around the core 34 and covers the inlet 30.

The antenna 20 of the RF transponder 14 may be an inductive or a capacitive antenna and the RF processor 18 may be an inductive or a capacitive processor. An inductive antenna 20 in the form of a loop with two ends is shown positioned on the inlet in FIGS. 12-14. The RF processor 18 is in electrical contact with the ends of the loop. One end of the loop is coupled to one of the terminals of the RF processor 18 while the other end of the loop utilizes a bridging connector to couple to the other terminal of the RF processor 18.

The environmental condition sensor 16 is in communication with the RF processor 18 and may be built directly into the radio frequency integrated circuit or connected to the RF circuit by a link. Alternatively, the sensor 16 can operate by wireless signal transfer, so that a physical link between the sensor 16 and processor 18 is not required. The sensor 16 may be active or passive, depending on the type of power source utilized. In a preferred embodiment, the sensor 16 is a MEMS (micro electromechanical system) sensor and is utilized to read environmental or other conditions, including physical and chemical properties, in the vicinity of the sensor. The sensor 16 may include at least one accelerometer. Other types of sensors are also contemplated for use with the invention. Examples of environmental properties that may be sensed by one or more sensors include temperature, pressure, humidity, head space gas detection and concentration (oxygen, carbon dioxide, nitrogen, etc.), vitamin concentration determination (vitamin depletion), microbiological agents (E. Coli, broad spectrum—bacteria, molds), shock, vibration, strain, acoustics, angle, magnetic field, seismic properties, tilt, and noise, among other conditions. Multiple sensors may be utilized with a single or multiple RF processors. One type of passive sensor that may be utilized, for example, to read a temperature is manufactured by SCS of San Diego, Calif. A type of active sensor that may be utilized, for example, to record temperature data is manufactured by KSW of Germany. Other types of sensors may also be utilized.

The power source of the system is used for powering the RF transponder 14 and sensor 16. The transponder 14 is often powered to sense an environmental condition using the environmental condition sensor 16, without requiring a separate power source for the sensor. Certain types of sensors 16 also require independent power in order to operate the sensor, and the power needed by the sensor 16 may be provided by the same battery 32 that is utilized to power the processor 18 or by a separate battery. The power source may be provided by several separate devices, or a single device, depending upon such factors as whether the system is active, semi-active, or passive, as well as other factors.

Where a passive system is utilized, a battery 32 is not coupled to the transponder 14 and a power source powers the processor 18 and the sensor 16 to sense a condition when powered by the power source. With the passive system, the power source will typically be an RF reader 40 that sends a signal to the RF transponder 18 when it is time to record an environmental condition. The signal that is sent to the RF transponder 14 by the reader 40 is utilized to power the processor 18 and sensor 16 to record an environmental condition. The environmental condition may then be stored in the RF transponder 14 as environmental condition data and/or may be transmitted back to the RF reader 40. Where a separate power source is necessary to power the sensor 16, a battery 32 may be coupled to the sensor. When the RF reader 40 powers the transponder, the transponder 14 sends a signal to the sensor 16 to record an environmental condition. The environmental condition data is transmitted to the transponder 14 and/or the RF reader 40.

With a semi-passive or active system, a battery 32 is electrically coupled to the RF processor 18 and is used to power the processor 18 and sensor 16 to record environmental condition data. With both systems, the battery 32 is used to power the transponder 14 and sensor 16 to record environmental condition data as a function of time. The transponder 14 may include a real time clocking mechanism, such as a timer, and be programmed to record data periodically, or when specified events occur. The environmental condition data is stored in the transponder 14, where it may be accessed by the reader 40.

With the semi-passive system, the environmental condition data is read from the transponder 14 whenever the transponder is interrogated by an RF reader 40. The reader may then write over the existing data in the transponder 14, or may leave the data in the transponder and add additional data. With an active system, the environmental condition data may be transmitted to an RF reader 40 without requiring the reader to interrogate the transponder 14. An active system will generally require a more powerful battery than with a semi-passive system. A system is “active” in that the transponder 14 can perform its own tasks and order certain functions without requiring input from another device. The processor 18 in both the active and semi-passive systems can be timed by a timer so that readings occur at spaced intervals or on a continuous basis. With the active system, the processor 18 can also be timed with a timer to transmit data to the RF reader 40 at intervals, or on a continuous basis. Thus, with an active and a semi-passive system, environmental condition data may be recorded at a greater frequency than with a passive system, which requires that the transponder 14 be interrogated by a reader 40. In summary, with the semi-passive system, two different power sources are necessary, while with the passive and active systems, only a single power source is required. Those of skill in the art will recognize that various signal conditioning circuitry may be required intermediate the sensor 16 and the RF processor 18 depending on the type of sensor utilized and the nature of the electrical outputs.

The system also preferably includes a log of location and environmental condition data and a reporting infrastructure. The log of location data 42 may be separate from or the same as the log of environmental condition data 44, and both logs 42, 44 are preferably recorded as a function of time. In an alternative embodiment, location as a function of environmental condition is recorded, without requiring recordation of time.

The reporting infrastructure preferably includes at least one RF reader 40 and a central data processing computer 52 and station 54. The central data processing computer 52 includes software and hardware, as known by those of skill in the art for transmitting data to a local area network (“LAN”) or a web page. The reporting infrastructure also preferably includes anti-collision software for use in accommodating multiple transponder and sensor reads at one time. The reporting infrastructure includes the software necessary to record and relay data measurements across all sectors of the distribution chain 10. The data reporting software may handle single, multiple, and total sector coverage scenarios.

The at least one RF reader 40 of the reporting infrastructure is utilized to read information that is stored in the memory of the RF transponder 14, including inventory information and data. The inventory information may include information that is stored in the transponder 14 before the item of inventory leaves the point of origin L1, and data that is added to the RF transponder 14 during the item's distribution along the distribution chain 10. The data may include environmental condition data and location data. The environmental condition data is data that is recorded from the environmental condition sensor 16 and the location data is data that is input to the RF transponder 14 during the distribution process. The location data 42 is typically input by a user using a reader or other transmitter. The reporting infrastructure may be customized to the particular application and type of environmental conditions being recorded.

The log of location data 42 and the log of environmental condition data 44 may be transmitted to the reporting infrastructure in a number of different ways. In one embodiment, the logs of data 42, 44 may be stored in the RF transponder 14 and transmitted to the reporting infrastructure when read by a reader 40 and instructed by the programming of the reporting infrastructure to transmit to the computer processor 52. In an alternative embodiment, the logs of data 42, 44 may be directly transmitted to the reporting infrastructure when the data is read by the reader 40, without storing any of the data in the RF transponder 14 memory. In yet a further embodiment, the logs of data may be manually recorded in a handwritten list. The manually recorded data 42, 44 is transferred to the reporting infrastructure by entering the data into the computer 52 using a data entry device. The data that is stored in the RF transponder 14 is preferably transmitted to the reporting infrastructure using an RF reader 40 that reads the RF transponder 14 and transmits the data to the reporting infrastructure using software programmed into the RF reader 40 and the computer processor 52 of the reporting infrastructure.

The reporting infrastructure may also include a data report 56 that is generated by the software stored in the computer processor 52. The data report 56 preferably includes a record of the environmental condition as a function of location. The data report 56 may also include instructions to the user as to whether any detrimental environmental factors were encountered during the distribution process. One type of data report that may be generated is a graph of the environmental condition as a function of location and time, as shown in FIGS. 2, 5, and 8.

The reporting infrastructure preferably also includes software for converting the sensor data that is generated by the environmental condition sensor 16 into digital data, processing the digital data, and analyzing the processed data to determine whether the sensed data exceeds any limits that are associated with the item of inventory 12. For example, where an item of inventory 12 is sensitive to a particular environmental condition, such as temperature or shock, a threshold limit 58 may be programmed into the reporting infrastructure computer programming so that the software can determine whether to signal the user that a detrimental event has occurred. The threshold limit 58 may be set as an absolute limit, or may be calculated based upon time at a certain level. For instance, the limit for a parameter such as shock may be set at an absolute level, which, when surpassed, will result in a signal to the user. With a parameter such as temperature or humidity, the limit may be determined based upon the product exceeding a certain level for a given period of time, or exceeding an absolute limit. Both types of limits may be incorporated, if so desired.

RF readers 40 may be positioned throughout the distribution chain 10. For instance, readers 40 may be positioned at the processor's packaging station(s), warehouse storage, transit vehicles, cooler boxes, restaurant holding coolers, etc. Areas of greatest importance are business transfer points where the responsibility of the goods exchanges hands. Alternatively, with an active or semi-passive system, a reader 40 may only be required at the final destination LE, where the environmental condition data 44 may be read and transferred to the reporting infrastructure. A variety of distribution scenarios are discussed below, in connection with FIGS. 1-11. The RF reader 40 may be a hand held device or a stationary device.

FIGS. 1-6 depict a distribution chain 10 where the location data 42 is recorded manually. The data 42 may be recorded as a list on a piece of paper 48, or may be recorded electronically in an electronic device, such as a hand held computer, or input through a data entry device, such as a keyboard, to the computer processor 52 of the reporting infrastructure. Location data 42 is preferably recorded as a function of time whenever an item of inventory 12 leaves the custody of a custodian. For example, in FIG. 1, the log of location data 42 is recorded when the item of inventory 12 leaves L1, leaves a transport vehicle (transport 1) that transports the item of inventory from L1 to L2, leaves L2, leaves a transport vehicle (transport 2) that transports the item of inventory from L2 to L3, leaves L3, and leaves a transport vehicle (transport 3) that transports the item of inventory from L3 to LE. Custody may be presumed to exist in the next custodian when the item of inventory 12 leaves the custody of the prior custodian.

In FIG. 1, the log of location data 42 is manually recorded on a list 48 that is generated while the item of inventory 12 travels along the distribution chain 10. The list may be included with packing slips for the item of inventory 12 and stored in a pouch that is attached to the side of the item of inventory 12, among other ways for maintaining a list. FIG. 1 represents a semi-passive system, where environmental condition data is periodically and regularly transmitted to the RF transponder 14 and stored in the transponder. An RF reader 40 is shown positioned at each location L1, L2, L3, LE and powers the transponder to read the data stored in the RF transponder 40. Each time the data is read by the reader 40, it is transmitted to the computer processor 52. While the reader 40 is shown positioned at each location, readers may alternatively be positioned at numerous points in each location. In addition, readers 40 may be utilized during transport. In this distribution chain 10, the read data from the RF transponder 14 is transmitted immediately to the computer processor 52. All of the sensed data may be recorded in the RF transponder 14 if memory size permits. Alternatively, sensed data may be erased from the RF transponder each time the data is read by the RF reader 40 in order to free up more memory in the transponder 14.

FIG. 2 shows an illustrative graph 56 of temperature as a function of location and time for an item of inventory 12 as it travels along a distribution chain 10, like that of FIG. 1. This graph may be generated by the software in the reporting infrastructure once the item of inventory 12 has reached its final destination LE and the log of location data 42 as a function of time has been input into the computer processor 52. A similar but shortened version of the graph 56 may also be generated before the item of inventory 12 reaches the final destination LE because environmental condition data 44 is reported to the computer processor 52 whenever the RF transponder is read by the RF reader 40 The graph 56 shows a threshold limit 58 for temperature, shown by the dashed line, and represents an example of the conditions a refrigerated item of inventory 12 may encounter during the distribution process. During time period A, the product leaves L1 and encounters slight temperature fluctuations during transport 1. During time period B, the product enters L2 and is left unrefrigerated for the duration of time that it is in L2 such that the temperature of the item of inventory 12 rises above the threshold limit 58. During time period C, when the item of inventory leaves L2, it is refrigerated during transport 2 and returns to its original temperature by the time it reaches L3. Time periods D and E are uneventful and the product remains at approximately the same temperature until it arrives at the final destination LE. As is evident, the item of inventory 12 is likely ruined because it exceeded the threshold limit 58 for temperature. The data report 56 from the reporting software can alert the user as to when the detrimental event occurred and determine the custodian who caused the detrimental event. In this manner, the party that damaged the goods can be held accountable for destroying the product.

FIG. 3 shows another scenario where the log of location data 42 is manually recorded and input into the computer processor 52 of the reporting infrastructure at the final destination LE. The RF transponder 14 and sensor 16 are part of a semi-passive system where the transponder 14 and sensor 16 are powered by a battery 32 so that environmental data is recorded periodically over time and stored in the RF transponder 14. In this embodiment, however, only one RF reader 40 is utilized and is positioned at the final destination LE. The RF reader 40 reads the environmental condition data stored in the transponder 14 and transmits the data to the computer processor 52, where the data may be processed.

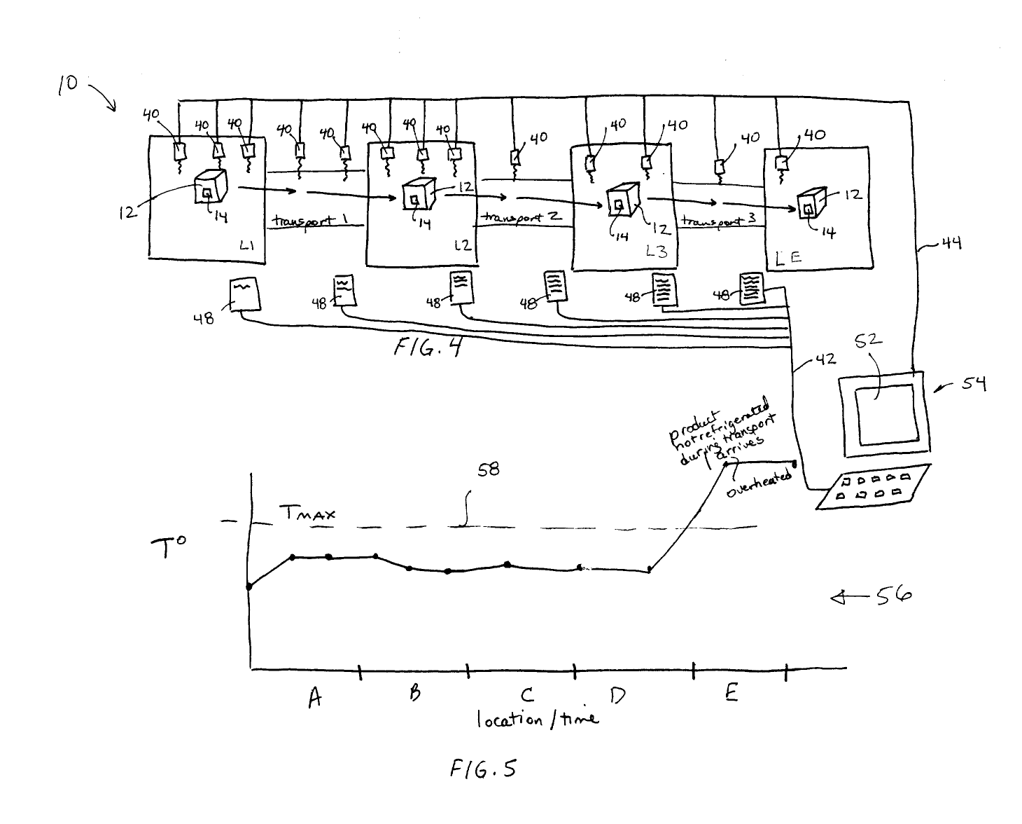

FIG. 4 shows another distribution chain 10 where the log of location data 42 is manually recorded as a list 48 of data. The location data is recorded and transmitted at each transfer point to the reporting infrastructure, either by input into the computer processor 52 directly by a data entry device, through a web page, or via other known input techniques. In this embodiment, the RF transponder 14 and sensor 16 are part of a passive system, where the transponder 14 and sensor 16 are not powered by a battery 20. The power for sensing a condition is provided by an RF reader 40, which powers the RF transponder 14 to read an environmental condition using the sensor 16. In this embodiment, the environmental condition data 44 may be both stored in the RF transponder 14 and automatically transferred to the computer processor 52 for use in the reporting infrastructure. This embodiment is conducive to generating a report 56 periodically, as the item of inventory 12 travels along the distribution chain 10. In an alternative embodiment, the sensed data is transmitted to the reporting infrastructure at the time of the reading, but is not stored in the RF transponder 14.

FIG. 5 is an illustrative graph 56 of temperature as a function of location and time for an item of inventory 12 as it travels along a distribution chain 10, like that in FIG. 4. This graph 56 may be generated by the software in the reporting infrastructure once the item of inventory 12 has reached its final destination LE and the log of location data 42 as a function of time has been input into the computer processor 52. A similar, but shortened version of the graph 56 may also be generated before the item of inventory 12 reaches the final destination LE because environmental condition data is 44 reported to the computer processor 52 whenever the RF transponder 14 is read by the RF reader 40. Like FIG. 2, the graph 56 shows a threshold limit 58 for temperature, represented by the dashed line. During time period A, the product leaves L1 and encounters a slight temperature rise during transport 1 because the refrigeration unit is set at a higher temperature on transport 1 than that in L1. During time period B, the product enters L2 and the temperature of the product decreases because the refrigeration unit at L2 is set at a lower temperature than that of transport 1. Temperature remains nearly constant during time period C and D until the item of inventory leaves L 3 and is positioned on transport 3. The item of inventory is not properly refrigerated on transport 3. As a result the temperature increases above a threshold level 58 and remains at this level until the temperature is read at LE. As is evident, the item of inventory 12 is likely destroyed because it exceeded the threshold limit 58. The data report 56 from the reporting software can alert the user as to when the detrimental event occurred and identify the custodian who caused the detrimental event.

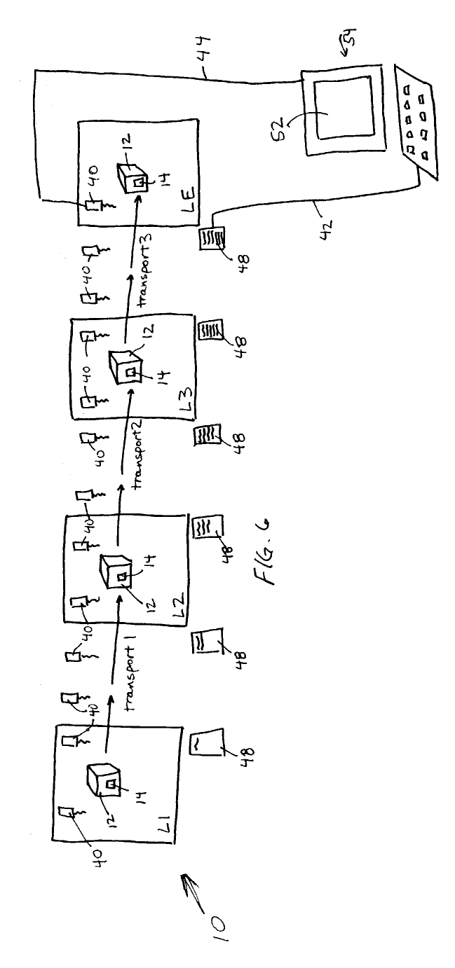

FIG. 6 illustrates another embodiment where the location data 42 is manually recorded, similar to that discussed above in connection with FIGS. 1 and 3. In this embodiment, the RF transponder 14 and sensor 16 are part of a passive system, where the transponder 14 and sensor 16 are not powered by a battery 20. The power for sensing a condition is provided by an RF reader 40, which powers the RF transponder 14 to read an environmental condition using the sensor 16. Readers 40 are positioned at numerous locations throughout the distribution chain 10. It is preferred that a reading is taken at least when the item of inventory 12 enters a new location and when the item leaves a location. It is also desirable to take a reading using the reader 40 at various intervals while the item of inventory 12 is stored at a particular location L1, L2, L3, LE. With this embodiment, each time that the reader 40 powers the RF transponder 14, the environmental condition data is stored in the RF transponder 14 for later use. Then, at the final destination LE, the RF reader 40 powers the RF transponder 14 for the final environmental condition reading, and also reads all the data stored in the RF transponder 14 and communicates the data to the computer processor 52. In this embodiment, it is not necessary that the reader 40, at the initial L1 and intermediate locations L2, L3, communicate with the computer processor 52, since all the environmental condition data 44 is stored in the RF transponder 14. This embodiment is conducive to generating a report 56 of the environmental condition after the item of inventory 12 has arrived at the final destination LE.

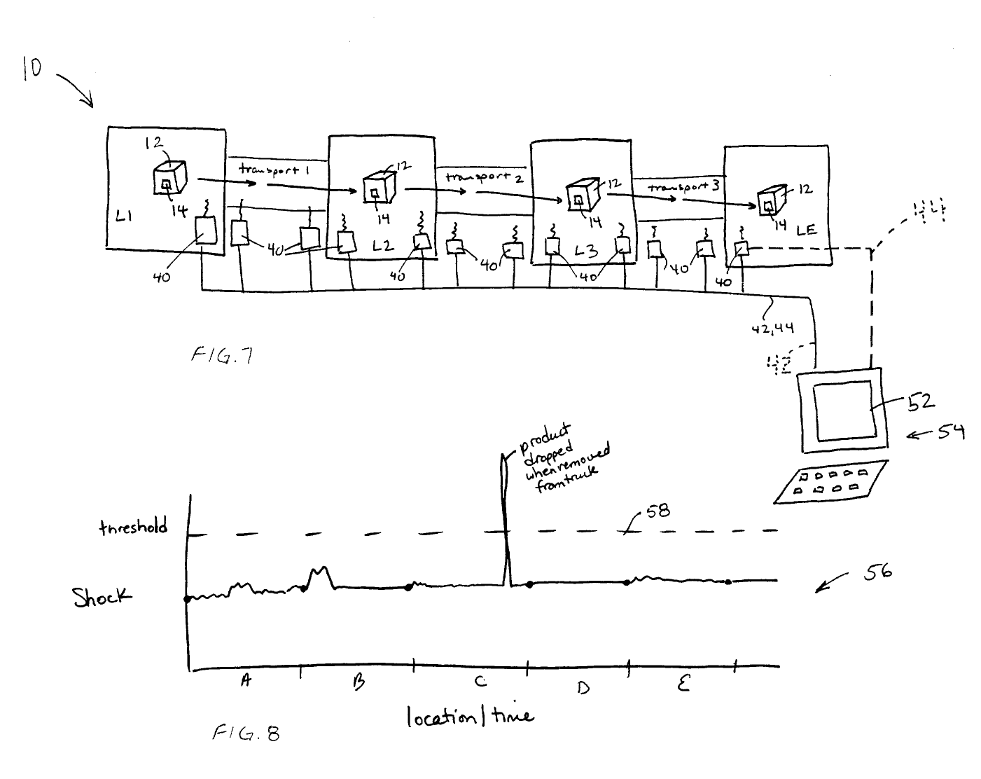

FIG. 7 is an embodiment of the distribution chain 10 where the location data 42 is provided by an RF reader 40 each time the reader 40 communicates with the RF transponder 14. The location data 42 as a function of time is input to the reporting infrastructure electronically, rather than generating a manual, hand-written list 48. In this embodiment, a reader 40 is shown positioned at both the exit to each location and the entrance to each location. In an alternative embodiment, the reader 40 may be positioned in either the exit or the entrance of each location, if desired to reduce the number of readers 40 and/or the number of readings. In FIG. 7, location data 42 is stored in the reader 40 so that when the reader 40 communicates with the RF transponder 14, it can communicate both information regarding the item of inventory 12 that is stored in the transponder 14 and attach the location information to the inventory information by forwarding the information to the reporting infrastructure. The location data 42 is not stored in the RF transponder 14, although later embodiments do store such data in the transponder 14. In this embodiment, the RF transponder 14 and sensor 20 are semi-passive and environmental condition data 44 is stored regularly and periodically. Each time a reader 40 reads the RF transponder 14, the environmental condition data 44 is transmitted to the reporting infrastructure. In this way, a partial report of environmental condition versus location may be generated, if so desired.

FIG. 7 also depicts an embodiment of the distribution chain 10 where the location data 42 is electronically transmitted by a reader 40 that has been programmed with location data 42 and the RF transponder 14 and sensor 16 are semi-passive and record environmental condition data 44 regularly and periodically. In this embodiment, represented by both the solid line and the dashed line connecting the reader 40 at LE to the computer processor 52, the location data 42 is recorded for the particular item of inventory 12 and transmitted to the reporting infrastructure each time that the reader 40 communicates with an RF transponder 14. Data relating to the item of inventory 12 that is stored on the RF transponder 14 is attached to the location data 42 provided by the reader 40 so that the item of inventory 12 is recognized. The environmental condition data 44 is stored in the RF transponder 14 and is read by a reader 40 at the final destination LE, as represented by the dashed line. In this manner, all the environmental condition data 44 is stored in the RF transponder 14 and released once the final destination LE is reached. This embodiment is not conducive to periodic environmental condition reports.

FIG. 8 is a graph 56 showing an illustrative example of shock as a function of location and time for an item of inventory 12 as it travels along a distribution chain 10, like that of FIG. 7. This graph 56 may be generated by the software in the reporting infrastructure once the item of inventory has reached its final destination LE and the log of location data 42 and log of environmental condition data 44 has been transmitted to the computer processor 52. The graph 56 shows a threshold limit 58 for shock, represented by the dashed line. During time period A, the product leaves L1 and enters transport 1. The item of inventory 12 is transported to L2 and encounters slight movement during transport. During time period B, the product enters L2 and is moved to a location in the warehouse (thus experiencing some shock while being moved) and then rests in the warehouse until it enters transport 2. During time period C, the item of inventory encounters minor shock waves during initial transport and is then dropped as the item of inventory is removed from transport 2. As a result, the shock reading escalates above the threshold level 58, possibly resulting in damage to the item of inventory 12. During time period D, the product rests at L3 and during time period E, the item of inventory 12 undergoes transport in transport 3 to LE. During transport, the item of inventory 12 encounters slight shock levels. As is evident, the item of inventory may have been damaged while associated with transport 2 because the threshold level of shock was exceeded when the item of inventory 12 was dropped. The data report 56 from the reporting software can alert the user as to when the detrimental event occurred and identify the custodian who caused the detrimental event.

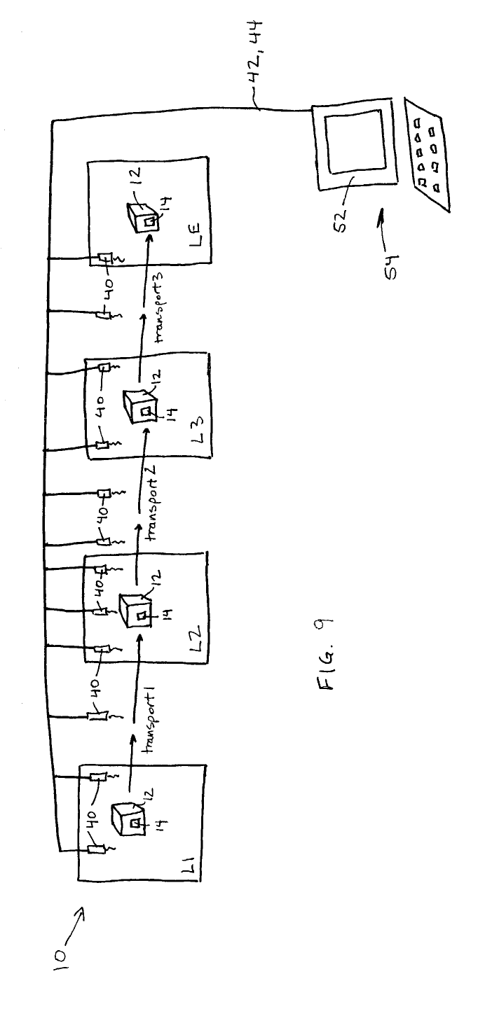

FIG. 9 represents an alternative embodiment of a distribution chain 10, where the location data 42 is provided by a reader 40 positioned at each location L1, L2, L3, LE and the RF transponder 14 and sensor 16 operate on a passive system. Like the prior embodiments of FIG. 7, location data 42 is stored in the reader 40 at each location L1, L2, L3, LE and is transmitted to the computer processor 52 of the system each time the RF transponder 14 is read. The system takes the information stored in the RF transponder 14 relating to identification of the item of inventory 12 and transmits the location and time for each item of inventory 12 during each reading to the computer processor 52. With respect to environmental condition, a reading of the environmental condition data 44 is only obtained when the reader 40 powers the RF transponder 14 to take a reading of the condition. Thus, it is desirable to read/power the RF transponder 14 at regular intervals in order to more fully chronicle the environmental condition of the item of inventory 12 as a function of time. Each time the reader 40 powers the transponder 14 to sense the environmental condition, the environmental condition is stored in the RF transponder 14 and transmitted to the reporting infrastructure. The location 42 and environmental condition data 44 are processed by the programming of the reporting infrastructure to correlate environmental condition with location. With this embodiment, it is possible to obtain an interim report of location and environmental condition data, if so desired. In FIG. 9, a single reader 40 for each reading location is utilized to handle both location and environmental condition data. However, it should be noted that more than one reader 40 can be used, one of which transmits location information and the other of which reads/powers the RF transponder 14.

FIG. 9 also depicts another embodiment of the distribution claim 10, where location data is transmitted to the RF transponder 14 by the reader 40 at each location, similar to that discussed for the first embodiment of FIG. 9, and an RF transponder 14 and sensor 16 that are passive. A reader 40 is used to power and read the RF transponder 14. Each time that a reader 40 powers the RF transponder 14, environmental condition data 44 is stored in the RF transponder 14. When the item of inventory 12 reaches the final destination LE, the RF transponder 14 will have stored all the environmental condition data 44 that resulted from powering of the transponder 14. The RF reader 40 at the final destination LE reads and transmits the data 44 to the computer processor 52, where the environmental condition data 44 is correlated with location data 42.

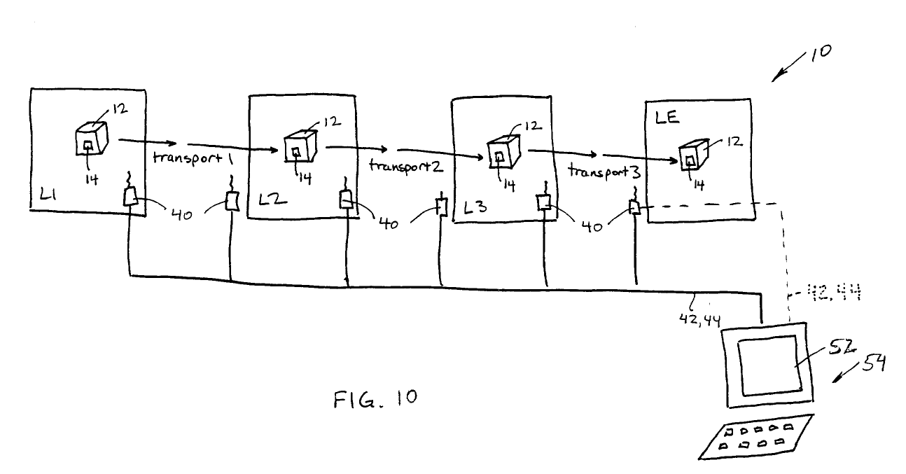

FIG. 10 depicts yet another embodiment of the distribution chain 10 for an item of inventory 12. In this embodiment, the RF transponder 14 and sensor 16 operate on a semi-passive system so that environmental condition data 44 is recorded at regular intervals, as governed by a timer that is coupled to the RF transponder 14. The RF reader 40 holds location data 42 and communicates the location data to the RF transponder 14, which then stores the location data 42 in the transponder 14. Environmental condition data 44 is also stored in the transponder 14. Each time the reader 40 reads the transponder, the location and environmental condition data are transmitted to the computer processor 52. In this way, a duplicate log of location and environmental condition data is generated.

FIG. 10 also depicts an alternative embodiment of the distribution path for an item of inventory 12 where location data 42 is transmitted by the reader 40, and the RF transponder 14 and sensor 16 are part of a semi-passive system. Environmental condition data 44 is recorded at regular intervals and stored in the RF transponder 14. In addition, the reader 40 is utilized at each location to transmit location information to the RF transponder 14. Thus, a complete log of location 42 and environmental condition data 44 is stored in the RF transponder 14. The reader 40 at the final destination LE, represented by the dashed line in FIG. 10, reads all the information stored in the RF transponder 14, including location 42 and environmental condition 44 data, and transmits the data to the reporting infrastructure.

In FIG. 7, the readers 40 are shown as communicating with the RF transponder 14 whenever the item of inventory 12 is about to leave a location or transport. While this technique is an effective way to monitor location, and requires only one communication of location information per location, it is also possible to communicate location information when an item of inventory 12 enters or leaves a location (shown in FIG. 10) or at intermediate points within a particular location (shown in FIGS. 9 and 11), the invention not being limited to communicating location at a particular point or at a single point.

FIGS. 9 and 11 represent distribution chains 10 where the RF transponder 14 and sensor 16 are part of a passive system. A reader 40 is utilized to power the transponder 14 to record an environmental condition 44 and the recorded environmental condition is stored in the RF transponder 14. In addition, a reader 40 is utilized to transmit location data 42 and the location data 42 is stored in the RF transponder 14 each time that the RF transponder 14 is read. In FIG. 9, each time that a reader 40 powers a transponder 14 and the sensor 16 senses an environmental condition, the environmental condition may be both transmitted to the reporting infrastructure and stored in the RF transponder 14. At the final destination LE, any stored location and environmental condition data 42, 44 is transmitted to the reporting infrastructure for further processing. In FIG. 11, the RF transponder 14 records both location and environmental condition data 42, 44 each time the transponder is powered by a reader 40. This data is stored in the transponder 14 until the final destination LE, where a reader 40 reads the information stored in the transponder 14 and transmits the data to the reporting infrastructure at one time.

A variety of commercially available inlets and processors are contemplated for use with the claimed invention. For example, inlet suppliers include Poly Flex Circuits, Cross Technologies, and Global ID. Processor suppliers include Philips Semiconductor, Temic, and E.M. The preferred inlets are low profile in order to avoid marking the paper on the roll.

It should be noted that RF processor 18 and antenna 20 combinations other than those discussed above or shown in the figures may be utilized with the invention. For instance, while a preferred embodiment includes positioning the RF processor 18, sensor 16, and battery 32 on an inlet 30, these components may, alternatively, be deposited directly on the surface of the item of inventory 12 without the need for an inlet, as shown in FIG. 14. Furthermore, while the antenna 20 is generally positioned on the inlet 30, the antenna 20 may be positioned on the surface of the item of inventory 12 instead of on the inlet 30. For example, the antenna 20 could be conductive ink that is printed onto the surface of the item of inventory 12. When the antenna 20 is positioned directly on the surface of the item of inventory 12, the RF processor 18, which is electrically coupled to the antenna 20, is positioned on a substrate or may be independent of a substrate. The antenna 20 may be positioned on the surface of the item of inventory 12 utilizing any known technique, such as printing a conductive ink, sputter coating a conductive material, and hot foil stamping, among other known antenna depositing techniques. Furthermore, the RF processor 18 may be coupled to the antenna 20 by leads, connectors, interposers, or other known techniques for coupling an RF processor to an antenna.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. A system for monitoring an environmental condition associated with an item of inventory along a distribution chain having a plurality of locations, wherein the plurality of locations includes at least a point of origin and a final destination, the system comprising:
at least one item of inventory;
an RF transponder associated with the at least one item of inventory, said transponder including an RF processor having an antenna coupled to the RF processor;
at least one environmental condition sensor in communication with the RF transponder on the at least one item of inventory;
a power source for powering the RF transponder and the at least one environmental condition sensor, wherein the RF transponder receives an environmental condition from the environmental condition sensor for storage as environmental condition data;
a log of location data;
a log of environmental condition data; and
a reporting infrastructure for processing the location data and the environmental condition data.

2. The system of claim 1, wherein the RF processor comprises memory and the log of environmental condition data is stored in at least one of the reporting infrastructure and the RF processor memory; and the log of location data is stored in at least one of the reporting infrastructure and the RF processor memory.

3. The system of claim 1, wherein the reporting infrastructure comprises a computer processor and a computer input device, and the computer processor includes programming for correlating the environmental condition data with the location data.

4. The system of claim 3, wherein the reporting infrastructure further comprises a data reporting medium and the data reporting medium is a computer display, a LAN, or a web page.

5. The system of claim 1, wherein the item of inventory comprises a roll of paper.

6. The system of claim 5, wherein the roll of paper has a core, and the RF transponder and environmental condition sensor are associated with the paper core.

7. The system of claim 1, wherein the environmental condition sensor is a MEMS.

8. The system of claim 1, wherein the log of location data is a list of data comprising location information recorded whenever the item of inventory at least one of enters and leaves a location; and the log of environmental condition data comprises environmental condition data recorded whenever an environmental condition is sensed by the environmental condition sensor.

9. The system of claim 8, wherein the tranponder comprises memory and the power source is a battery electrically coupled to the transponder and the environmental condition sensor, and the environmental condition sensor is associated with a timer for periodically sensing and recording the environmental condition data as a function of time and storing it in the transponder memory.

10. The system of claim 9, further comprising at least one RF reader associated with each of the locations, wherein the reader is configured to read the environmental condition data stored in the transponder when the item of inventory at least one of leaves and enters the location and transmit the environmental condition data to the reporting infrastructure.

11. The system of claim 9, further comprising an RF reader associated with the final destination, wherein the reader is configured to read the environmental condition data stored in the transponder memory when the item of inventory enters the final destination and transmit the environmental condition data to the reporting infrastructure.

12. The system of claim 8, wherein the power source is an RF reader configured to read and write to the RF transponder, with at least one reader associated with each of the plurality of locations, wherein the RF reader powers the RF transponder and environmental condition sensor to sense the environmental condition.

13. The system of claim 12, wherein a plurality of RF readers are provided at spaced locations along the distribution chain for powering the RF transponder to sense an environmental condition each time the RF reader powers the RF transponder.

14. The system of claim 13, wherein the plurality of RF readers are configured to communicate the sensed environmental condition to the reporting infrastructure at the time the condition is sensed to generate the log of environmental condition data.

15. The system of claim 13, wherein the RF processor comprises memory and the sensed environmental condition from each powering of the RF reader is stored in the RF processor memory as the log of environmental condition data, and an RF reader positioned at the final destination is configured to read the log of environmental condition data and transmit the environmental condition data to the reporting infrastructure.

16. The system of claim 8, wherein the location data of the log of location data is provided by a plurality of RF readers, each of which is programmed with location information and at least one of which is associated with each location along the distribution chain.

17. The system of claim 16, wherein the transponder comprises memory and each of the plurality of RF reader is configured to transmit the location information stored therein as a function of time to at least one of the reporting infrastructure and the RF transponder each time the reader communicates with the RF transponder.

18. The system of claim 17, wherein the power source is a battery electrically coupled to the transponder and the environmental condition sensor, and the environmental condition sensor is associated with a timer for periodically sensing and recording the environmental condition data as a function of time and storing it in the transponder memory.

19. The system of claim 18, wherein at least one of the plurality of readers is configured to read the environmental condition data from the RF transponder memory and communicate the data to the reporting infrastructure.

20. The system of claim 18, wherein the RF reader positioned at the final destination is the only reader configured to read the environmental condition data from the RF transponder memory and communicate the data to the reporting infrastructure.

21. The system of claim 17, wherein the power source is an RF reader configured to read and write to the transponder memory, with at least one reader associated with each of the plurality of locations, wherein the RF reader powers the RF transponder and environmental condition sensor to sense the environmental condition and the sensed environmental condition is stored in the RF transponder memory as the log of environmental condition data.

22. The system of claim 21, wherein each of the plurality of readers is configured to read the environmental condition data stored in the log of environmental condition data and transmit the data to the reporting infrastructure.

23. The system of claim 21, wherein only the RF reader positioned at the final destination is configured to read the environmental condition data stored in the log of environmental condition data and transmit the data to the reporting infrastructure.

24. The system of claim 15, wherein the reader is configured to transmit location information as a function of time to at least one of the RF transponder and the reporting infrastructure each time the reader communicates with the RF transponder to generate the log of location data.

25. The system of claim 1, wherein the environmental condition sensor is coupled to the RF processor with a connector.

26. The system of claim 1, wherein the environmental condition sensor is coupled to the RF processor by wireless communication.

27. The system of claim 1, wherein the RF transponder includes a timer for timing the environmental condition sensor to sense the environmental condition at equally spaced time intervals.

28. The system of claim 1, wherein the item of inventory includes a closeable bag, and the RF transponder is associated with at least one of an external surface of the bag, an internal surface of the bag, and a product in the bag.

29. The system of claim 1, wherein the environmental condition includes at least one of chemical, physical, or physiological properties.

30. A method of tracking an environmental condition associated with an item of inventory along a distribution chain having a plurality of locations, said plurality of locations including at least a point of origin and a final destination, said method comprising:
providing an item of inventory having an associated RF transponder, an environmental condition sensor, and a power source, said power source for powering the environmental condition sensor to sense an environmental condition;
repeatedly powering the RF transponder and the environmental condition sensor as the item of inventory travels along the distribution chain to read the environmental condition and generate a log of environmental condition data;
repeatedly determining a location of the item of inventory as the item of inventory travels along the distribution chain and generating a log of location data; and
correlating the log of location data and the log of environmental condition data using a reporting infrastructure.

31. The method of claim 30, wherein the RF transponder comprises memory and further comprising storing inventory data in the transponder memory at the point of origin.

32. The method of claim 30, wherein the reporting infrastructure comprises a computer processor having memory and the RF transponder comprises memory, the log of location data is stored in at least one of the RF transponder memory and the computer processor memory, and the powering step includes storing the log of environmental condition data in at least one of the RF transponder memory and the computer processor.

33. The method of claim 32, wherein the powering step is performed by an RF reader, which powers the RF transponder and environmental condition sensor to sense the environmental condition.

34. The method of claim 33, wherein the powering step further comprises transmitting the environmental condition data from the RF transponder to the reader.

35. The method of claim 30, wherein the generating a log of the location data step includes manually preparing a log of location as a function of time, the reporting infrastructure includes a computer processor having an input device, and further comprising inputting the manually generated data into the reporting infrastructure utilizing the input device.

36. The method of claim 30, wherein the RF transponder comprises memory and is associated with a timer that is utilized to signal the sensor to sense an environmental condition at spaced time intervals, and the powering step includes sensing an environmental condition continually and at spaced time intervals and storing the sensed environmental condition in the RF transponder memory as the log of environmental condition data.

37. The method of claim 36, wherein the powering step is performed by a battery that is coupled to the RF transponder and the environmental condition sensor.

38. The method of claim 36, wherein the determining the location step includes utilizing a reader having a programmed location and transmitting the location information from the reader to the RF transponder memory to generate the log of location data when the item of inventory at least one of enters and leaves each of the locations along the distribution chain.

39. The method of claim 36, wherein the determining the location step includes utilizing a reader having a programmed location and transmitting the location information from the reader to the reporting infrastructure to generate the log of location data when the item of inventory at least one of enters and leaves each of the locations along the distribution chain.

40. The method of claim 36, further comprising reading the environmental condition data stored in the RF transponder memory at the final destination with a reader and transmitting the environmental condition data to the reporting infrastructure.

41. The method of claim 38, further comprising reading the log of location data at the final destination with an RF reader and transmitting the log of location data to the reporting infrastructure.

42. The method of claim 30, further comprising analyzing the correlated log of environmental condition data and the log of location data to determine a course of action based upon the analysis.
